(19) United States
(12) Patent Application Publication
(10) Pub. No.: US 2022/0336816 A1
(43) Pub. Date: Oct. 20, 2022

(54) NONAQUEOUS ELECTROLYTE SECONDARY BATTERY

(71) Applicant: Prime Planet Energy & Solutions, Inc., Tokyo (JP)

(72) Inventor: Naoki OSADA, Toyota-shi (JP)

(21) Appl. No.: 17/722,372

(22) Filed: Apr. 17, 2022

(30) Foreign Application Priority Data
Apr. 19, 2021 (JP) 2021-070239

(51) Int. Cl. H01M 4/62

(52) U.S. Cl. CPC H01M 4/625; H01M 2004/028

(57) ABSTRACT

The nonaqueous electrolyte secondary battery disclosed herein includes an electrode assembly including a positive electrode and a negative electrode, and a nonaqueous electrolyte. The positive electrode includes a positive electrode current collector and a positive electrode active material layer formed on the positive electrode current collector. The positive electrode active material layer has an average film thickness of 100 μm or more. The positive electrode active material layer includes a positive electrode active material having a mean particle diameter of 10 μm or less, and, as an electroconductive material, carbon nanotubes and another electroconductive carbon material. The carbon nanotubes have an average length of 1 μm or more to 2 μm or less, and an average diameter of 10 nm or less. In a cross-sectional electron microscope image of the positive electrode active material layer, the electroconductive material is dispersed.

### CROSS REFERENCE TO RELATED APPLICATIONS

The present application is based upon and claims the benefit of priority from Japanese patent application No. 2021-070239 filed on Apr. 19, 2021, and the entire disclosure of which is incorporated herein in its entirety by reference.

### BACKGROUND OF THE DISCLOSURE

### 1. Technical Field

The present disclosure relates to a nonaqueous electrolyte secondary battery.

### 2. Description of the Background

Nonaqueous electrolyte secondary batteries, such as lithium ion secondary batteries, are lighter and have higher energy density than existing batteries. Thus, nonaqueous electrolyte secondary batteries are used suitably as high-output power sources for vehicles or power sources for personal computers and portable terminals. Typical structures of positive and negative electrodes (hereinafter referred to simply as “electrodes” unless a specific distinction is made between positive and negative electrodes) provided in this type of secondary battery are such that an electrode active material layer containing an electrode active material as a main component is formed on one or both sides of a foil-shaped electrode current collector. The electrode active material layer is formed by coating the surface of a current collector with a slurry (paste) of electrode material prepared by dispersing solid contents such as an electrode active material, a binding material (binder), and an electroconductive material in a predetermined solvent, drying the coating, and then applying press pressure to the coating to have a predetermined density and thickness.

One of the objects to increase the performance of the secondary batteries is to increase the density of the electrode active material layer to achieve higher energy density. When the density of the electrode active material layer is increased, the gas which may be generated during charging and discharging tends to remain within the electrode active material layer, making it difficult to be discharged outside, for example. The remaining of such gas in the electrode active material layer may cause a reduction in performance of the secondary batteries. For example, Japanese Patent Application Publication No. 2018-98211 discloses an electrode where a gas channel is provided in the surface and/or inside the electrode active material layer to reduce the remaining gas.

### SUMMARY

In order to further increase the energy density of the secondary batteries, the electrode active material with a relatively small mean particle diameter (e.g., 10 μm or less) is used to further improve the density of the electrode active material layer, and to increase the thickness of the electrode active material layer. The use of such an electrode active material with a relatively small particle diameter to increase the thickness of the electrode active material layer achieves the high energy density, but tends to cause gas generated in charging and discharging to remain, as mentioned above. As a result of study, the present inventors found an abnormal behavior of charge and discharge curves caused by remaining of gas and a reduction in charge and discharge efficiency in the early stage of charging and discharging in which generation of the gas is prominent.

The present disclosure was made in view of the circumstances described above, and main objective of the present disclosure is to provide a nonaqueous electrolyte secondary battery having higher charge and discharge efficiency even in the early stage of charging and discharging.

In order to achieve the objective, a nonaqueous electrolyte secondary battery disclosed herein is provided. The nonaqueous electrolyte secondary battery disclosed herein includes an electrode assembly including a positive electrode and a negative electrode, and a nonaqueous electrolyte. The positive electrode includes a positive electrode current collector and a positive electrode active material layer formed on the positive electrode current collector. The positive electrode active material layer has an average film thickness of 100 μm or more. The positive electrode active material layer includes a positive electrode active material having a mean particle diameter of 10 μm or less, and, as an electroconductive material, carbon nanotubes and another electroconductive carbon material. The carbon nanotubes have an average length of 1 μm or more to 2 μm or less, and an average diameter of 10 nm or less. In a cross-sectional electron microscope image of the positive electrode active material layer, the electroconductive material is dispersed.

With this configuration, even if a positive electrode active material layer containing a positive electrode active material with a relatively small mean particle diameter is formed to have an average film thickness of 100 μm or more, the electroconductive material is dispersed, thereby forming a network having electroconductivity. This allows the gas which may be generated during charging and discharging to be discharged suitably to the outside of the positive electrode active material layer. Accordingly, even in an early stage of charging and discharging in which generation of the gas is relatively prominent, a secondary battery with excellent charge and discharge efficiency can be achieved.

In one aspect of the secondary battery disclosed herein, when a cross-sectional electron microscope image of a 50 μm square of the positive electrode active material layer is divided into n equal regions, and areas of the electroconductive material in each of the regions are represented by S1, S2 [ . . . ] Sn (%) (n is a natural value of 6 to 8), a variation of the areas S1, S2 [ . . . ] Sn (%) is within 15%. In another aspect, an average value of the areas S1, S2 [ . . . ] Sn (%) of the electroconductive material is 6% to 9%.

With this configuration, the electroconductive material is dispersed, and a network having electroconductivity is suitably formed. Accordingly, a nonaqueous electrolyte secondary battery having higher charge and discharge efficiency can be provided even in an early stage of charging and discharging.

In one aspect of the secondary battery disclosed herein, the other electroconductive carbon material is carbon black.

The use of carbon black, which has really high electroconductivity, as an electroconductive material can improve discharge capacity and enhance charge and discharge efficiency.

### BRIEF DESCRIPTION OF THE DRAWINGS

FIG. 1 is a schematic explanatory view of a lithium ion secondary battery according to an embodiment.

FIG. 2 is a view of charge and discharge curves in an early stage according to Example 1.

FIG. 3 is a view of charge and discharge curves in an early stage according to Example 2.

FIG. 4 is a view of charge and discharge curves in an early stage according to Example 3.

### DETAILED DESCRIPTION

Some desired embodiments of the technology disclosed herein will be described below with reference to the accompanying drawings. The matters necessary for executing the present disclosure (e.g., the general configuration and constitution process of the nonaqueous electrolyte secondary battery), except for matters specifically herein referred to can be grasped as design matters of those skilled in the art based on the related art in the preset field. The technology disclosed herein can be executed based on the contents disclosed herein and the technical knowledge in the present field. In the following drawings, the same members/portions which exhibit the same action are denoted by the same reference numerals, and the duplicated descriptions may be omitted or simplified. The dimensional relation (such as the length, width, and height) does not reflect the actual dimensional relation.

The expression “A to B” (A and B are any numerical values) indicating herein a range means A or more to B or less.

The “secondary battery” herein is a term that indicates all electricity storage devices that can be repeatedly charged and discharged, and is a concept that encompasses so-called secondary batteries (chemical batteries) such as a lithium ion secondary battery and a nickel hydrogen battery and capacitors (physical batteries) such as an electric double layer capacitor. The “nonaqueous electrolyte secondary battery” means a commonly used battery which uses a nonaqueous electrolyte as a charge carrier and can be repeatedly charged and discharged with transfer of the charge carrier between the positive and negative electrodes. The “electrode active material (i.e., the positive electrode active material or the negative electrode active material)” means a compound which can reversibly store and release a chemical species that serves as the charge carrier (a lithium ion in the lithium ion secondary battery).

The nonaqueous electrolyte secondary battery disclosed herein includes an electrode assembly including a positive electrode and a negative electrode, and a nonaqueous electrolyte. Although not intended to be particularly limited thereto, the technology disclosed herein will be described in detail below as an example of a lithium ion secondary battery including a flat wound electrode assembly and a nonaqueous electrolyte as one embodiment.

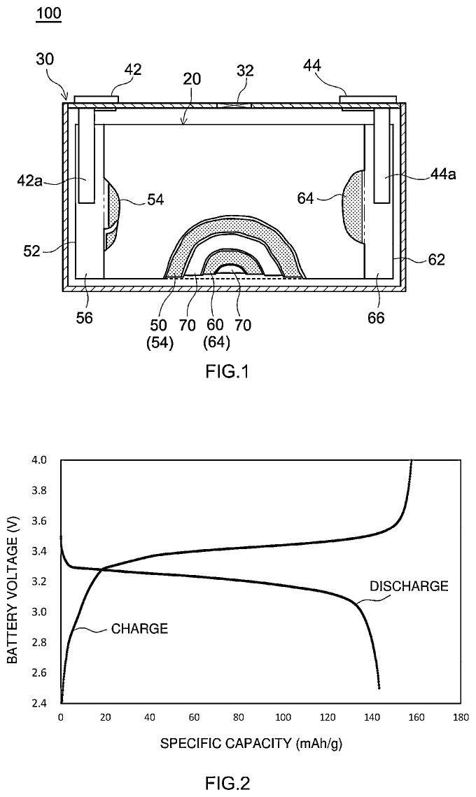

A lithium ion secondary battery 100 shown in FIG. 1 is constituted by housing a flat wound electrode assembly 20 and a nonaqueous electrolyte (not shown) in a hermetically sealable box-shaped battery case 30. The battery case 30 includes a positive electrode terminal 42 and negative electrode terminal 44 for external connection, and a thin-walled safety valve 32 set to release an internal pressure of the battery case 30 when the internal pressure increases to a predetermined level or higher. The battery case 30 is provided with an inlet (not shown) for introducing the nonaqueous electrolyte. The positive electrode terminal 42 is electrically connected to a positive electrode current collector 42a. The negative electrode terminal 44 is electrically connected to a negative electrode current collector 44a. The material of the battery case 30 is desirably a metal material having high strength, a light weight, and high thermal conductivity, and examples of the metal material include aluminum and steel.

The wound electrode assembly 20 is typically in a form where a long sheet-shaped positive electrode (hereinafter referred to as a positive electrode sheet 50) and a long sheet-like negative electrode (hereinafter referred to as a negative electrode sheet 60) are stacked via a separator 70, and is wound in the longitudinal direction. The positive electrode sheet 50 has a configuration where a positive electrode active material layer 54 is formed on one or both surfaces of a long sheet-like positive electrode current collector 52 along the longitudinal direction. The negative electrode sheet 60 has a configuration where a negative electrode active material layer 64 is formed on one or both surfaces of a long sheet-like negative electrode current collector 62 along the longitudinal direction.

A positive electrode current collector exposed portion 56 (i.e., a portion of the positive electrode current collector 52 exposing without formation of the positive electrode active material layer 54) and a negative electrode current collector exposed portion 66 (i.e., a portion of the negative electrode current collector 62 exposing without formation of the negative electrode active material layer 64) which are formed to extend outward from both ends of the wound electrode assembly 20 in the winding axis direction are joined to the positive electrode current collector 42a and the negative electrode current collector 44a, respectively.

The positive electrode sheet 50 includes a positive electrode active material layer 54 on the positive electrode current collector 52. Examples of the positive electrode current collector 52 include metal materials such as aluminum, nickel, titanium, and stainless steel, having high electroconductivity. Among them, the positive electrode current collector 52 is particularly desirably aluminum (e.g., an aluminum foil). Although not particularly limited thereto, the thickness of the positive electrode current collector 52 is, for example, 5 μm or more to 35 μm or less, desirably 7 μm or more to 20 μm or less.

The positive electrode active material contained in the positive electrode active material layer 54 has a mean particle diameter of typically 10 μm or less. For example, the mean particle diameter may be 0.5 μm or more to 10 μm or less, or 1 μm or more to 9 μm or less. The positive electrode active material with a mean particle diameter within the above range can suitably ensure a contact area with the electroconductive material, thereby enhancing electron conductivity and forming a favorable electroconductive path within the positive electrode active material layer 54.

The “mean particle diameter” herein is a particle diameter (D₅₀, also referred to as a median diameter) corresponding to the particle diameter at a cumulative value of 50% of small particle side in the volume-based particle size distribution based on commonly used laser diffraction/scattering method.

The positive electrode active material used is not particularly limited as long as the mean particle diameter is 10 μm or less, and may be a positive electrode active material which has been used in a positive electrode of secondary battery. Specifically, the positive electrode active material can be a lithium-transition metal composite oxide such as a lithium-nickel based composite oxide and a lithium phosphate compound such as lithium iron phosphate (LiFePO₄). Among them, in the technology disclosed herein, the positive electrode active material used is desirably a lithium phosphate compound.

The lithium phosphate compound has composition represented by the general formula: Li_{1+y}MPO₄, contains, as constituent elements, a lithium element and at least one transition metal element, and is a phosphate having an olivine type crystal structure. In the general formula, y is a value satisfying 0.05≤y≤0.3, M may be at least on metal element selected from the group consisting of Fe, Mn, Co, Ni, Mg, Zn, Cr, Ti, and V. One type, or two or more types of the lithium phosphate compounds which have been used in the nonaqueous electrolyte secondary battery can be used without particular limitations. Specific examples of the lithium phosphate compound include lithium iron phosphate (LiFePO₄), lithium manganese phosphate (LiMnPO₄), and lithium nickel phosphate (LiNiPO₄). The positive electrode active material layer 54 desirably contains lithium iron phosphate (LiFePO₄) among them. In the lithium iron phosphate, phosphoric acid forms a stable structure; thus oxygen is less prone to be released even at high temperatures, and thermal stability is excellent. Further, the lithium ion phosphate is relatively inexpensive because of using iron, which is an abundant resource compared to other compounds. The lithium iron phosphate may further be coated with a carbon film.

The electroconductive material contained in the positive electrode active material layer 54 includes typically carbon nanotubes and another electroconductive carbon material. According to the results of the earnest study by the present inventors, the positive electrode active material layer containing carbon nanotubes and the other electroconductive carbon material achieves a secondary battery having high charge and discharge efficiency even when the positive electrode active material layer containing a positive electrode active material with a relatively small particle diameter (e.g., a mean particle diameter of 10 μm or less) is formed to have an average film thickness of 100 μm or more. The reason for this is not particularly limited, but can be assumed as follows.

The electroconductive material has been used in this kind of secondary battery, but is not uniformly dispersed in the electrode active material layer. This may cause reaction unevenness. For example, the smaller the mean particle diameter of carbon black which may be used as a commonly used electroconductive material is, the purer and more electrically conductive it is, but the higher the cohesive power becomes. This tends to make uniform dispersion difficult. If the positive electrode active material with a relatively small mean particle diameter (e.g., 10 μm or less) is used, the density between solid particles (typically active materials) can be suitably increased by pressing the electrode active material layer. On the other hand, the gaps (voids) between the active materials become very small. Thus, gas generated in charging and discharging remains inside the electrode active material layer and is difficult to be discharged. When the gas remains inside the electrode active material layer, the contact area between the electrode active material layer and the nonaqueous electrolyte may decrease, and deinsertion of Li ions may be inhibited. Accordingly, the discharge capacity and the charge and discharge efficiency decrease. Particularly, in the early stage of charging and discharging in which generation of the gas is prominent, the charge and discharge efficiency is likely to decrease.

To address this problem, the present inventors found in the technology disclosed herein that the positive electrode active material layer containing, as an electroconductive material, carbon nanotubes and another electroconductive carbon material achieve both electroconductivity and dispersibility, and a network having electroconductivity and voids is formed within the positive electrode active material layer. Accordingly, even in the early stage of charging and discharging in which generation of the gas is particularly prominent, a nonaqueous electrolyte secondary battery which causes reduced gas remaining in the electrode active material layer and has high charge and discharge efficiency can be achieved.

Carbon nanotubes (hereinafter also referred to as CNTs) have electroconductivity and a high tap density, and can maintain a high void fraction (e.g., about 30% to about 70%) even when aggregated. Thus, a network having a suitable electroconductivity is likely to be formed in the electrode active material layer, and when gas is generated, the gas can be discharged outside of the electrode active material layer through the network. This can further improve discharge capacity and charge and discharge efficiency.

The CNTs may be single-walled carbon nanotubes (SWNTs) made of a single cylindrical graphene sheet, a double-walled carbon nanotubes (DWNTs) made of two different SWNTs nested together, or a multi-walled carbon nanotubes (MWNTs) made of three or more SWNTs nested together. In order to ensure the void fraction when CNTs are aggregated, the CNTs are desirably multi-walled carbon nanotubes. These CNTs may be used alone or in combination of two or more of them. The carbon nanotubes may be produced by arc discharge method, laser ablation method, chemical vapor deposition method, or the like.

In light of achievement of appropriate dispersion and aggregation, the average length of the CNTs is typically 1 μm or more to 2 μm or less. With the average length within such a range, a network having suitable electroconductivity can be formed between electrode active materials. An average diameter of the CNTs is typically 10 nm or less. For example, the average diameter may be 1 nm or more to 10 nm or less, 2 nm or more to 9 nm or less.

As the average length and the average diameter of the CNTs, values obtained by measurement using an electron microscopy can be employed, for exampl.

Although not particularly limited thereto, the purity of the CNTs is typically desirably 85% or more because suitable electroconductivity can be obtained with higher purity. The purity of the CNTs is desirably 90% or more, more desirably 95% or more. Although not particularly limited thereto, the upper limit of the purity of the CNTs may be typically 99% or less, 98% or less in light of the ease of production.

The “purity of the CNTs” herein can be determined by thermogravimetric analysis (TGA).

As the other electroconductive carbon material, electroconductive carbon materials which have been used as electroconductive materials in this type of secondary battery can be used without particular limitations. Specifically, the other electroconductive carbon material includes carbon black, coke, active carbon, graphite (natural graphite and a modified product thereof, artificial graphite), carbon fibers (PAN carbon fibers, pitch carbon fibers), fullerene, graphene, and the like. Among them, carbon black having really high electroconductivity is desirably employed as the other electroconductive carbon material.

The properties of carbon black are not particularly limited, but the smaller the mean particle diameter, the wider the specific surface area, and the wider the contact area with the positive electrode active material, which is advantageous in improving electroconductivity. On the other hand, if the mean particle diameter is too small, carbon black tends to be bulky, which may reduce the energy density. In light of this point, the mean particle diameter of the carbon black may be typically in the range from 1 nm to 200 nm (e.g., 10 nm to 100 nm) Specific examples of the carbon black include acetylene black, furnace black, ketjen black, and thermal black. Among them, the carbon black is desirably acetylene black because of having really high electroconductivity and contributing to the high output of the secondary battery.

In light of achieving both electroconductivity and dispersibility, the mass ratio between the carbon nanotubes and the other electroconductive carbon material is adjusted, as appropriate. Although not particularly limited thereto, the mass ratio between the carbon nanotubes (CNTs) and the other electroconductive carbon material is desirably CNTs:the other electroconductive carbon material=90:10 to 50:50. When the CNTs and the other electroconductive carbon material are contained at the above-described mass ratio, the above-described effects are further exhibited.

In the technology disclosed herein, the electroconductive material is required to be dispersed in the cross-sectional image of the active material layer obtained using an electron microscope (both of scanning electron microscope (SEM) and a transmission electron microscope can be used.). Being dispersed means, for example, that the electroconductive material and the binding material (binder) are present without being unevenly distributed in some regions, i.e., they are present at an average volume ratio relative to the active material within any area in the electrode, and the electroconductive material is continuously connected to the electrode in the thickness or plane direction. When the electroconductive material is dispersed, a network which can ensure electroconductivity can be formed while the gas generated within the electrode active material layer is suitably discharged. Accordingly, a secondary battery with high charge and discharge efficiency can be achieved.

In one aspect, when a cross-sectional electron microscope image of a 50 μm square of the positive electrode active material layer was divided into n equal regions (n is a natural number of 6 to 8), area ratios (S1 to Sn) of the electroconductive material in the respective regions are calculated, the variation of the area ratios S1 to Sn is desirably within 15%. The variation is more desirably within 14%, particularly desirably within 12%. As a result of earnest study, the present inventors found that when the variation of the area ratios (S1 to Sn) of the electroconductive material in the respective regions is within the above-described range, the electroconductive material is appropriately dispersed, and a network having electroconductivity is suitably formed.

An average value of the area ratios (S1 to Sn) of the electroconductive material in the positive electrode active material layer 54 is desirably 6% to 9%. With the average value within the above-described range, the balance between the positive electrode active material and the electroconductive material in the positive electrode active material layer 54 is suitably adjusted, and the output characteristics of the secondary battery can be improved.

The variation of the area ratios (S1 to Sn) of the electroconductive material within the positive electrode active material layer and the average value of the area ratios are determined as follows, for example. Cross-sectional images (e.g., five or more images) of 50 μm square of the positive electrode active material layer are obtained using an electron microscope. In each of the obtained cross-sectional images, carbon elements are mapped by an electron probe microanalyzer (EPMA), and regions where the electroconductive material is present (typically regions with a concentration of carbon element of 12% or more) are specified. Accordingly, regions where the electroconductive material is present, and regions where the other solid component (typically the positive electrode active material) is present can be distinguished. The cross-sectional image is divided into n equal regions (n is a natural number of 6 to 8), and area ratios (S1 to Sn) of the electroconductive material in the respective regions can be determined. The area ratios are calculated for each of the cross-sectional image in the manner described above, and an average value of the area ratios is determined. Thus, the average value of the area ratios herein can be determined. The variation of the area ratios can be calculated from the average value of the area ratios calculated. Accordingly, the variation of the area ratios of the electroconductive material in the positive electrode active material layer herein and the average value of the area ratios can be determined.

In another aspect, multiple arbitrary straight lines are set in the cross-sectional image of the obtained positive electrode active material layer, and the length d1 (μm) of a region where the electroconductive material is present and the length d2 (μm) of a region where the other solid content is present on each of the straight lines are measured, the ratio of d1 to d2 (d1/d2) is 0.1 or more to 0.3 or less. Although not particularly limited thereto, d1 is about 0.5 μm to about 3 μm. With this configuration, the gas generated in the electrode active material layer is suitably discharged, and inhibition of the contact between the electrode active material layer and the nonaqueous electrolyte is reduced. This can further improve discharge capacity and charge and discharge efficiency.

The length d1 (μm) of a region where the electroconductive material is present and the length d2 (μm) of a region where the other solid content is present are determined as follows, for example Cross-sectional images (e.g., five images or more) of the positive electrode active material layer are obtained in the same manner as described above. The cross-sectional images are analyzed by the electron probe microanalyzer as mentioned above, and the regions where the electroconductive material is present, and the regions where the other solid content is present are distinguished. Then, multiple arbitrary straight lines (e.g., diagonals) are set on the cross-sectional image, and an average value of d1 and an average value of d2 on the straight lines are calculated. Values of d1 and d2 on each of the cross-sectional images are calculated in the same manner, and average values are determined, thereby determining values of d1 and d2. Based on these values of d1 and d2, the ratio (d1/d2) of d1 to d2 can be determined.

The positive electrode active material layer 54 may further contain any component besides the positive electrode active material and the electroconductive material, if necessary. The component can be a binder or the like. The binder used can be a polymer which can be dissolved or dispersed in a solvent used. Examples of the binder used include polyvinylidene fluoride (PVDF), styrene-butadiene rubber (SBR), polytetrafluoroethylene (PTFE), and carboxymethyl cellulose (CMC).

In light of the energy density, the content of the positive electrode active material in the positive electrode active material layer 54 (i.e., the proportion of the positive electrode active material in the total mass of the positive electrode active material layer) is desirably approximately 60 mass % or more. The content of the positive electrode active material is, for example, more desirably 75 mass % to 90 mass %, yet more desirably 80 mass % to 90 mass %. Further, the content of the electroconductive material in the positive electrode active material layer 54 is, for example, desirably 1 mass % to 10 mass %, more desirably 1 mass % to 8 mass %. The content of the binder in the positive electrode active material layer 54 is, for example, desirably 0.5 mass % to 5 mass %, more desirably 1 mass % to 3 mass %. If the positive electrode active material layer 54 contains various additives such as a thickener, the content of the additives in the positive electrode active material layer 54 is, for example, desirably 7 mass % or less, more desirably 5 mass % or less.

In light of achievement of higher capacity, the average thickness of the positive electrode active material layer 54 (the thickness of one side of the positive electrode current collector 52 is required to be 100 μm or more. The average thickness of the positive electrode active material layer 54 may be 100 μm or more to 200 μm or less, or 110 μm or more to 190 μm or less. In light of achievement of higher energy density, the mass (the mass per unit area) of the positive electrode active material layer 54 provided per unit area of the positive electrode current collector 52 may be 20 mg/cm² or more (e.g., 25 mg/cm² or more, typically 27 mg/cm² or more) per one side of the positive electrode current collector 52. The mass (the mass per unit area) of the positive electrode active material layer 54 provided per unit area of the positive electrode current collector 52 may also be typically 60 mg/cm² or less (e.g., 55 mg/cm² or less) per one side of the positive electrode current collector 52. In light of achievement of gas discharge and energy density, the density of the positive electrode active material layer 54 is desirably 2.0 g/cm³ or more to 3.0 g/cm³ or less, more desirably 2.1 g/cm³ or more to 2.5 g/cm³ or less.

The negative electrode sheet 60 includes a negative electrode active material layer 64 on the negative electrode current collector 62. The negative electrode current collector 62 is made of, for example, a metal material such as copper having suitable electroconductivity, an alloy made mainly of copper, nickel, titanium, and stainless steel. Among them, copper (e.g., a copper foil) is particularly desirably employed. The thickness of the negative electrode current collector 62 may be, for example, approximately 5 μm to 20 μm, desirably 8 μm to 15 μm

The negative electrode active material layer 64 at least contains a negative electrode active material. One kind, or two or more kinds of the materials known as a negative electrode active material of this kind of secondary battery may be used as the negative electrode active material. Suitable examples of the negative electrode active material include carbon materials such as graphite, hard carbon, and soft carbon. The negative electrode active material is typically granule. The mean particle diameter of the granule negative electrode active material is not particularly limited and is, appropriately 50 μm or less, typically 20 μm or less, for example, 1 μm to 20 μm.

The negative electrode active material layer 64 may contain a material which can be used as a component of the negative electrode active material layer in the commonly used nonaqueous electrolyte secondary battery, if necessary, in addition to the negative electrode active material. Examples of such a material include a binder and various additives. Examples of the binder used include styrene-butadiene rubber (SBR). In addition, various additives such as a thickener, a dispersant, and an electroconductive material can be used. For example, as the thickener, carboxymethyl cellulose (CMC), methyl cellulose (MC), or the like can be used suitably.

In light of the energy density, the content of the negative electrode active material in the negative electrode active material layer 64 is approximately desirably 60 mass % or more. The content of the negative electrode active material is, for example, more desirably 90 mass % to 99 mass %, and yet more desirably 95 mass % to 99 mass %. If the binder is used, the content of the binder in the negative electrode active material layer 64 is, for example, desirably 1 mass % to 10 mass %, more desirably 1 mass % to 5 mass %. If the thickener is used, the content of the thickener in the negative electrode active material layer 64 is, for example, desirably, 1 mass % to 10 mass %, more desirably 1 mass % to 5 mass %.

In light of achievement of higher capacity, the average thickness of the negative electrode active material layer 64 may be 100 μm or more to 200 μm or less, or 110 μm or more to 190 μm or less. In light of achievement of higher energy density, the mass (the mass per unit area) of the negative electrode active material layer 64 provided per unit area of the negative electrode current collector 62 may be 5 mg/cm² or more (e.g., 7 mg/cm² or more, typically 10 mg/cm² or more) per one side of the negative electrode current collector 62. The mass (the mass per unit area) of the negative electrode active material layer 64 provided per unit area of the negative electrode current collector 62 may also be typically 20 mg/cm² or less (e.g., 15 mg/cm² or less) per one side of the negative electrode current collector 62. The density of the negative electrode active material layer 64 may be 1.0 g/cm³ or more to 2.0 g/cm³ or less. The density of the negative electrode active material layer 64 may also be 1.1 g/cm³ or more to 1.8 g/cm³ or less.

The capacity ratio between the positive electrode and the negative electrode can be controlled based on the difference in characteristic of acceptance of the charge carrier and the like. Specifically, the ratio (Cₐ/C_{c}) between the positive electrode capacity C_{c}(Ah) and the negative electrode capacity Cₐ(Ah) is appropriately 1.0 to 2.0, desirably 1.5 to 1.9, more desirably 1.2 to 1.3. The positive electrode capacity C_{c}(Ah) is defined as the product of the theoretical capacity (Ah/g) per unit mass of the positive electrode active material and the mass (g) of the positive electrode active material. Similarly, the negative electrode capacity Cₐ(Ah) is defined as the product of the theoretical capacity (Ah/g) per unit mass of the negative electrode active material and the mass (g) of the negative electrode active material.

Examples of the separator 70 include porous sheets (films) made of resin such as polyethylene (PE), polypropylene (PP), polyester, cellulose, and polyamide. Such a porous sheet may have a monolayer structure, or a lamination structure of two or more layers (e.g., a three-layer structure where PP layers are stacked on both surfaces of a PE layer). The separator 70 may be provided with a heat-resistance layer (HRL).

The nonaqueous electrolyte used is typically a liquid (nonaqueous electrolyte) obtained by dissolving or dispersing a supporting electrolyte (e.g., a lithium salt, a sodium salt, or a magnesium salt, a lithium salt in a lithium ion secondary battery) in a nonaqueous solvent. Alternatively, the nonaqueous electrolyte may be a solid (typically a so-called gel) obtained by adding a polymer to the nonaqueous electrolyte.

The supporting electrolyte used can be a supporting electrolyte which has been used in this kind of secondary battery without particular limitations. Examples of the supporting electrolyte used include lithium salts such as LiPF₆, LiBF₄, LiAsF₆, LiCF₃SO₃, LiC₄F₉SO₃, LiN(CF₃SO₂)₂, and LiC(CF₃SO₂)₃. Among them, the supporting electrolyte used is desirably LiPF₆. The concentration of the supporting electrolyte may be, for example, 0.7 mol/L or more to 1.3 mol/L or less.

The nonaqueous solvent used can be any of carbonates, esters, ethers, nitriles, sulfones, lactones without particular limitations. Specifically, the nonaqueous solvent used is desirably any of ethylene carbonate (EC), diethyl carbonate (DEC), dimethyl carbonate (DMC), ethyl methyl carbonate (EMC), monofluoro ethylene carbonate (MFEC), difluoro ethylene carbonate (DFEC), monofluoromethyl difluoromethyl carbonate (F-DMC), and trifluorodimethyl carbonate (TFDMC). These nonaqueous solvents may be used alone or in combination of two or more of them, as appropriate.

The nonaqueous electrolyte of the nonaqueous secondary battery according to the present embodiment may further contain, for example, a gas generator such as biphenyl (BP) and cyclohexyl benzene (CHB); a film-forming agent; a dispersant; and thickener.

The nonaqueous electrolyte secondary battery disclosed herein is used for various applications. For example, the nonaqueous electrolyte secondary battery disclosed herein is characterized by high energy density and high charge and discharge efficiency in the early stage of charging and discharging. Therefore, with these characteristics, the nonaqueous electrolyte secondary battery disclosed herein is suitably used in, for example, power sources (power supply for driving) for motor installed in vehicles such as a plug-in hybrid vehicle (PHEV), a hybrid vehicle (HEV), and an electric car (BEV). Typically, the multiple nonaqueous electrolyte secondary batteries used are connected in series and/or parallel to be in an assembled battery.

Examples regarding the nonaqueous electrolyte secondary battery disclosed herein will be described below. However, it is not intended that the present disclosure is limited to such examples.

<Production of Positive Electrode>

### Example 1

A LiFePO₄ powder (LFP) with a mean particle diameter (D₅₀) based on the laser diffraction/scattering method of 6 μm as a positive electrode active material, carbon nanotubes (CNTs) with an average length of 2 μm and an average diameter of 8 nm as an electroconductive material, acetylene black (AB) as an electroconductive material, and polyvinylidene fluoride (PVdF) as a binder were provided. These materials were weighed to have a mass ratio LFP:CNTs:AB:PVdF=92:2.5:2.5:3, and mixed with N-methylpyrrolidone (NMP) as a solvent to prepare a positive electrode slurry with a solid content of 50%. This positive electrode slurry was applied to each of both surfaces of a long aluminum foil (positive electrode current collector) so as to have a thickness of 100 μm or more, and was then dried at 80° C. for 15 minutes. After the drying, the resultant was pressed so that the density of the positive electrode active material layer was 2.2 g/cm³. Thus, a positive electrode sheet including the positive electrode current collector and the positive electrode active material layer on the positive electrode current collector was obtained.

### Example 2

A LiFePO₄ powder (LFP) with a mean particle diameter (D₅₀) based on the laser diffraction/scattering method of 6 μm as a positive electrode active material, carbon nanotubes (CNTs) with an average length of 2 μm and an average diameter of 8 nm as an electroconductive material, and polyvinylidene fluoride (PVdF) as a binder were provided. These materials were weighed to have a mass ratio LFP:CNTs:PVdF=91:6:3, and mixed with N-methylpyrrolidone (NMP) as a solvent to prepare a positive electrode slurry with a solid content of 50%. Then, a positive electrode sheet was obtained in the same manner as in Example 1 except that the above-prepared positive electrode slurry was used.

### Example 3

A LiFePO₄ powder (LFP) with a mean particle diameter (D₅₀) based on the laser diffraction/scattering method of 6 μm as a positive electrode active material, acetylene black (AB) as an electroconductive material, and polyvinylidene fluoride (PVdF) as a binder were provided. These materials were weighed to have a mass ratio LFP:AB:PVdF=89:8:3, and mixed with N-methylpyrrolidone (NMP) as a solvent to prepare a positive electrode slurry with a solid content of 50%. Then, a positive electrode sheet was obtained in the same manner as in Example 1 except that the above-prepared positive electrode slurry was used.

### Reference Example

A LiFePO₄ powder (LFP) with a mean particle diameter (D₅₀) based on the laser diffraction/scattering method of 6 μm as a positive electrode active material, acetylene black (AB) as an electroconductive material, and polyvinylidene fluoride (PVdF) as a binder were provided. These materials were weighed to have a mass ratio LFP:AB:PVdF=90:7:3, and mixed with N-methylpyrrolidone (NMP) as a solvent to prepare a positive electrode slurry with a solid content of 50%. Then, a positive electrode sheet was obtained in the same manner as in Example 1 except that the positive electrode slurry was applied on the current collector so as to have an average film thickness of 100 μm or less.

<Evaluation of Positive Electrode Active Material Layer>

Five cross-sectional images (300×) of 50 μm square of each of the positive electrode active material layers of Examples 1 to 3 and Reference Example prepared as described above were obtained using a scanning electron microscope (SEM). The observation images obtained as described above were analyzed by an electron probe microanalyzer (EPMA) to map the carbon elements. The region where the concentration of the carbon elements was 12% or more was defined as the region where the electroconductive material is present, and the region where the electroconductive material is present and the region where the other solid content is present are distinguished.

Each of the cross-sectional images was divided into six equal regions, and the variation of the area ratios (S1 to S6) of the electroconductive material in the respective regions was calculated. Values of the variations of the area ratios was calculated for the cross-sectional images, and an average value of the variations was calculated. When the variation of S1 to S6 is within 15%, it is evaluated that the dispersion state of the positive electrode active material and the electroconductive material is good. The result of the evaluation as good dispersion state of the electroconductive material is indicated by “o”, and the result of the evaluation as uneven distribution of the electroconductive material is indicated by “×.” The results are shown in Table 1.

An average value of the area ratios of the electroconductive material of each of Examples and Reference Example was calculated. Table 1 shows the results.

On each of the cross-sectional images obtained and analyzed by an electron probe microanalyzer (EPMA), the lengths (d1) of the regions where the electroconductive material is present and the lengths (d2) of regions where the other solid content is present were measured. The diagonals were set on each of the cross-sectional images, and the lengths d1 (μm) of the electroconductive material and the lengths d2 (μm) of the other solid content were measured. An average value of d1 and an average value of d2 on the diagonals were calculated, and the ratio (d1/d2) of d1 to d2 was determined. Values of d1 and d2 on each of the cross-sectional images were determined, and an average value of the ratios (d1/d2) of d1 to d2 was calculated. Table 1 shows the results.

<Production of Lithium Ion Secondary Battery>

Graphite (C) as a negative electrode active material, a styrene-butadiene rubber (SBR) as a binder, and carboxymethyl cellulose (CMC) as a thickener were provided. These materials were weighed to have a mass ratio C:SBR:CNC=98:1:1, and mixed with distilled water as a solvent to prepare a negative electrode slurry with a solid content of 52%. This negative electrode slurry was applied to each of both surfaces of a long copper foil (negative electrode current collector). The negative electrode slurry on the negative electrode current collector was dried at 80° C. for 15 minutes. After the drying, the resultant was pressed so that the density of the negative electrode active material layer was 1.3 g/cm³. Thus, a negative electrode sheet including the negative electrode current collector and the negative electrode active material layer on the positive electrode current collector was obtained.

As a separator sheet, a porous polyolefin sheet having a three-layer structure of PE/PP/PE was provided.

The positive electrode sheet produced (Examples 1 to 3 and Reference Example) and the negative electrode sheet were stacked via the provided separator sheet, thereby producing an electrode assembly. Then, to the electrode assembly, a positive electrode terminal and a negative electrode terminal were connected, which was then housed in a laminate case together with a nonaqueous electrolyte. As the nonaqueous electrolyte, one obtained by dissolving LiPF₆ with a concentration of 1.0 mol/L as a supporting electrolyte in a mixed solvent containing ethylene carbonate (EC), dimethyl carbonate (DMC), and ethyl methyl carbonate (EMC) at a volume ratio of 30:40:30 was used. Thus, each of lithium ion secondary batteries of Examples 1 to 3 and Reference Example was obtained.

<Evaluation of Lithium Ion Secondary Battery>

The lithium ion secondary batteries of Examples 1 to 3 and Reference Example were placed in an environment at 25° C. Then, each of the lithium ion secondary batteries was charged with constant current (CC) at a rate of 0.33 C up to 4.0 V, then paused for 10 minutes, discharged with constant current (CC) at a rate of 0.33 C up to 2.5 V, and then paused for 10 minutes. At this time, the charge capacity from the start of the initial charging to the end of the same, and the discharge capacity from the start of the discharging to the end of the same were determined. A value obtained by dividing the charge capacity by the weight (g) of the positive electrode active material layer was calculated as a specific charge capacity (mAh/g), and a value obtained by dividing the discharge capacity by the weight (g) of the positive electrode active material layer was calculated as a discharging specific capacity (mAh/g). Further, a ratio of the specific discharge capacity to the specific charge capacity was calculated as charge and discharge efficiency (%). Table 1 shows the results.

“1 C” refers to the current value (current density) at which the battery capacity (Ah) predicted by the theoretical capacity for the active material can be charged in 1 hour. Thus, for example, 1/3 C refers to the current value at which the battery capacity can be charged in 3 hours, and 20 C refers to the current value at which the battery capacity can be charged in 1/20 hours.

For each of the lithium ion secondary batteries, an initial charge and discharge curves (transition of battery voltage) was obtained, and the presence or absence of abnormality of voltage behavior was evaluated. Table 1 and FIGS. 2 to 4 show the results.

TABLE 1

| | | | Electro- | | Area Ratio (S1 to | | | | | | | |
|---|---|---|---|---|---|---|---|---|---|---|---|---|
| | Average | Mean | conductive | | S6) of Electro- | | Dispersion | | | Specific | Specific | Charge |
| | Film | Particle | Material | | conductive Material | | of Electro- | | Abnormality | Charge | Discharge | Discharge |
| | Thickness | Diameter | (mass %) | | Variation | Average | conductive | | of Voltage | Capacity | Capacity | Efficiency |
| | (μm) | (μm) | CNTs | AB | (%) | Value (%) | Material | d1/d2 | Behavior | (mAh/g) | (mAh/g) | (%) |
| Ex. 1 | 148 | 6 | 2.5 | 2.5 | 12 | 8 | ∘ | 0.2 | None | 157.8 | 143.3 | 90.8 |
| Ex. 2 | 111 | 6 | 6 | 0 | 30 | 10 | x | 0.2 | Present | 159.7 | 136.6 | 85.5 |
| Ex. 3 | 152 | 6 | 0 | 8 | 24 | 7 | x | 0.08 | Present | 153.0 | 135.3 | 88.4 |
| Ref. | 43.5 | 6 | 0 | 7 | 25 | 10 | x | 0.1 | None | 158.9 | 147.1 | 92.5 |
| Ex. 1 | | | | | | | | | | | | |

As can be seen from Table 1 and FIG. 2, in Example 1 in which the positive electrode active material and the electroconductive material are suitably dispersed, an abnormality of voltage behavior in initial charging was not confirmed even when the average film thickness was 100 μm or more. Further, the charge and discharge efficiency was 90% or more.

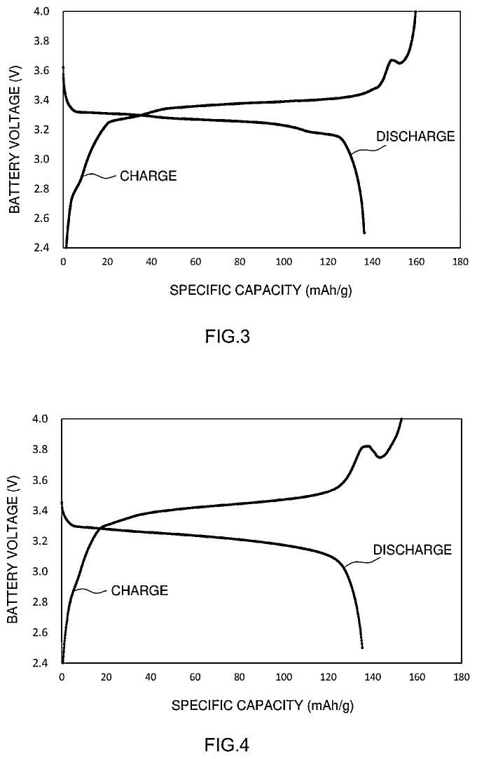

In contrast, in Examples 2 and 3, abnormalities in voltage behavior shown in FIGS. 3 and 4 were confirmed. Further, the charge and discharge efficiency was less than 90%.

Even when the positive electrode active material layer containing a positive electrode active material with a mean particle diameter of 10 μm or less is formed to have an average film thickness of 100 μm or more, the positive electrode active material layer contains carbon nanotubes with an average length of 1 μm or more to 2 μm or less and an average diameter of 10 nm or less, and another electroconductive carbon material, and the electroconductive material is dispersed in the positive electrode active material layer. This can achieve a nonaqueous electrolyte secondary battery with high charge and discharge efficiency even in the early stage of charging and discharging.

Although specific examples of the present disclosure have been described in detail above, they are mere examples and does not limit the appended claims.

The technology described is the appended claims include various modifications and changes of the foregoing specific examples.

What is claimed is:

1. A nonaqueous electrolyte secondary battery comprising:
an electrode assembly including a positive electrode and a negative electrode, and a nonaqueous electrolyte, wherein
the positive electrode includes a positive electrode current collector and a positive electrode active material layer formed on the positive electrode current collector,
the positive electrode active material layer has an average film thickness of 100 μm or more,
the positive electrode active material layer includes a positive electrode active material having a mean particle diameter of 10 μm or less, and as an electroconductive material, carbon nanotubes and another electroconductive carbon material,
the carbon nanotubes have an average length of 1 m or more to 2 μm or less,
the carbon nanotubes have an average diameter of 10 nm or less, and
in a cross-sectional electron microscope image of the positive electrode active material layer, the electroconductive material is dispersed.

2. The nonaqueous electrolyte secondary battery according to claim 1, wherein
when a cross-sectional electron microscope image of a 50 μm square of the positive electrode active material layer is divided into n equal regions, and areas of the electroconductive material in each of the regions are represented by S1, S2 [ . . . ] Sn (%) (n is a natural value of 6 to 8), a variation of the areas S1, S2 [ . . . ] Sn (%) is within 15%.

3. The nonaqueous electrolyte secondary battery according to claim 2, wherein
an average value of the areas S1, S2 [ . . . ] Sn (%) of the electroconductive material is 6% to 9%.

4. The nonaqueous electrolyte secondary battery according to claim 1, wherein
the another electroconductive carbon material is carbon black.
